(19) United States
(12) Patent Application Publication
(10) Pub. No.: US 2010/0264646 A1
(43) Pub. Date: Oct. 21, 2010

(54) STRUCTURES FOR WIRE ROUTING IN WIRED DRILL PIPE

(76) Inventor: Jean-Marc Follini, Houston, TX (US)

Correspondence Address: Conley Rose P.C, P.O.Box 3267, Houston, TX, 77253, US

(21) Appl. No.: 12/424,539

(22) Filed: Apr. 16, 2009

(51) Int. Cl. F16L 55/00

(52) U.S. Cl. 285/119

(57) ABSTRACT

A wire routing structure for a pipe joint includes a conductor conduit extending from one tool joint of a pipe joint to another tool joint of the pipe joint in a pattern having at least one component not aligned with a longitudinal axis of the pipe joint. In one example, the length of the conduit is selected such that the conduit is in axial compression. In another example, the conduit is disposed in a composite material structure affixed to an interior wall of the pipe joint. In another example, at least one tool joint in the pipe joint has a bore subtending a selected angle with respect to a longitudinal axis of the tool joint selected to induce the conduit when inserted therethrough to follow a helical pattern about the interior of the pipe joint.

### BACKGROUND OF THE INVENTION

1. Field of the Invention

The invention relates generally to the field of pipe used in wellbore drilling. More specifically, the invention relates to structures for “wired” drill pipe that may include a power and/or signal channel associated therewith.

2. Background Art

Rotary drilling systems known in the art for drilling wellbores through subsurface Earth formations typically use threadedly coupled segments (“joints”) of pipe suspended at the Earth's surface by a drilling unit called a “rig.” The pipe is used, in association with certain types of tools such as collars and stabilizers to operate a drill bit disposed at the longitudinal end of a “string” of such pipe joints coupled end to end. As a wellbore is drilled, and it becomes necessary to lengthen the string of pipe, additional joints of pipe are coupled to the string by threading them onto the upper (surface) end of the string of pipe. Removing the string of pipe from the wellbore, such as to replace a drill bit, requires uncoupling joints or “stands” (segments consisting of two, three or four coupled joints) of the pipe string and lifting the string from the wellbore. Such coupling and uncoupling operations are an ordinary and necessary part of drilling a wellbore using a rig and such pipe strings (“Drill strings”).

It is known in the art to include various types of measuring devices near the lower end of a drill string in order to measure certain physical parameters of the wellbore and the surrounding Earth formations during the drilling of the wellbore. Such instruments are configured to record signals corresponding to the measured parameters in data storage devices associated with the measuring devices. The measuring and storing devices require electrical power for their operation. Typically such power is provided by batteries and/or a turbine powered electrical generator associated with the measuring devices. The turbine may be rotated by the flow of drilling fluid (“mud”) that is pumped through a central passageway or conduit generally in the center of the pipes and tools making up the drill string. It is also known in the art to communicate certain signals representative of the measurements made by the devices in the wellbore to the Earth's surface at or close to the time of measurement by one or more forms of telemetry. One such form is extremely low frequency (“ELF”) electromagnetic telemetry. Another is modulation of the flow of mud through the drill string to cause detectable pressure and/or flow rate variations at the Earth's surface.

The foregoing power and telemetry means have well known limitations. It has bee a longstanding need in the art of wellbore drilling to provide electrical power and a relatively high bandwidth communication channel along a drill string from the bit to the Earth's surface. Various structures have been devised to provide insulated electrical conductors in association with drill pipe to provide such power and/or signal channels for a drill string. The features of these structures are related to the particular requirements for pipes used for drill strings, such as being constructed to cause minimize changes to the ordinary handling and operation of drill pipe. As will be appreciated by those skilled in the art, such handling includes repeated threaded coupling and uncoupling. Use of the pipe string during drilling will result in application to the pipe string of torsional stress, bending stress, compressional and tensional stress, as well as extreme shock and vibration.

One type of “wired” drill pipe is described in U.S. Patent Application Publication No. 2006/0225926 filed by Madhavan et al. The wired drill pipe disclosed in the '926 publication includes a conduit for retaining wires in the wall of or affixed to the wall of a joint of drill pipe, as well as electromagnetic couplings for the wires proximate the longitudinal ends of the pipe joint.

There continues to be a need for improvements to structures for wired drill pipe to increase their reliability and ease of handling during drilling operations.

### BRIEF DESCRIPTION OF THE DRAWINGS

FIG. 1 shows a segment (“joint”) of one example of wired drill pipe.

FIG. 1A shows another example of a non-straight wire conduit arrangement.

FIG. 2 shows a cross section of the pipe joint shown in FIG. 1.

FIG. 3 shows a cross section of another example of wired drill pipe.

FIG. 4 shows a cross section of another example of wired drill pipe.

FIG. 4A shows an additional protective layer applied to an entry point of a conduit into a bore in a tool joint.

FIG. 4B shows an alternative structure for a wire conduit.

FIG. 4C shows another possible structure for a wire conduit.

FIGS. 4D and 4E show other example structures for a wire conduit.

FIGS. 5 through 7 show a different type of conduit retainer inside a pipe joint.

FIG. 8 shows an example of forming an end of the conduit to retain it in place inside a bore in a tool joint.

FIGS. 8A and 8B show other examples of retaining ends of a conduit within a tool joint bore.

FIG. 8C shows another example of retaining ends of a conduit within a tool joint bore.

FIG. 9 shows another example of forming part of the conduit to retain it in place inside a bore.

FIG. 10 shows another example of a bore in a tool joint.

### DETAILED DESCRIPTION

The manner of use of wired drill pipe, and the basic principles of how to make such wired drill pipe, are well explained in U.S. Patent Application Publication No. 2006/0225926 filed by Madhavan et al., incorporated herein by reference. The present description provides illustrative examples of structures for wire routing a signal communication channel, such as a cable, within a drill pipe. For example, a guide tube may be routed in a drill pipe to provide a power and/or signal channel. The present description also provides examples of attaching wire routing guide tubes to a segment of drill pipe. As used herein, the term “wired drill pipe” is intended to include any drill pipe having a signal communication channel therein, such as an insulated electrical conductor and/or an optical fiber associated with a joint of drill pipe. “Guide tube” will be referred to herein as a “conduit” for controlling and at least partially enclosing the signal communication channel.

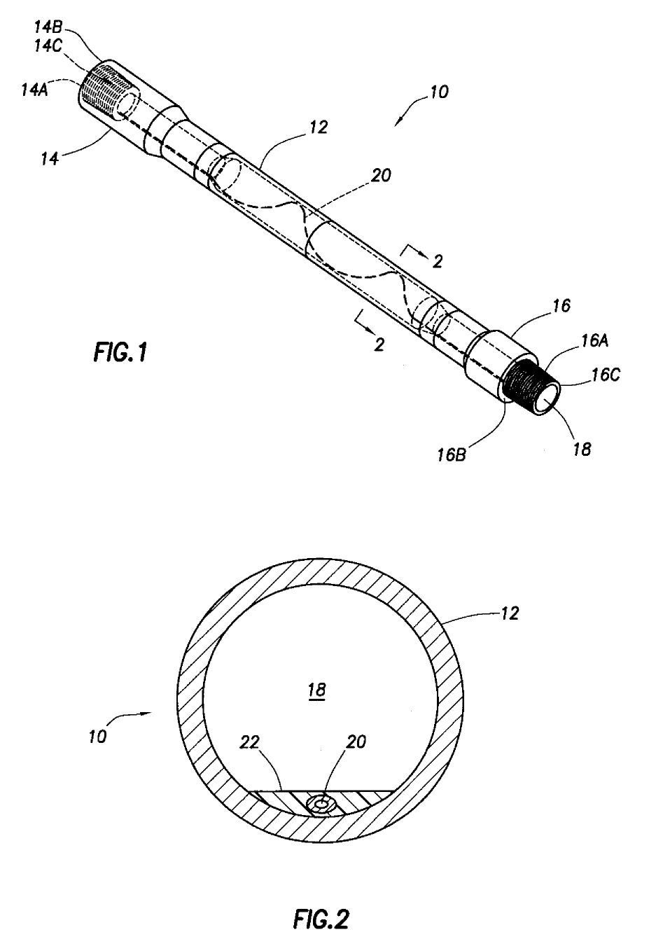

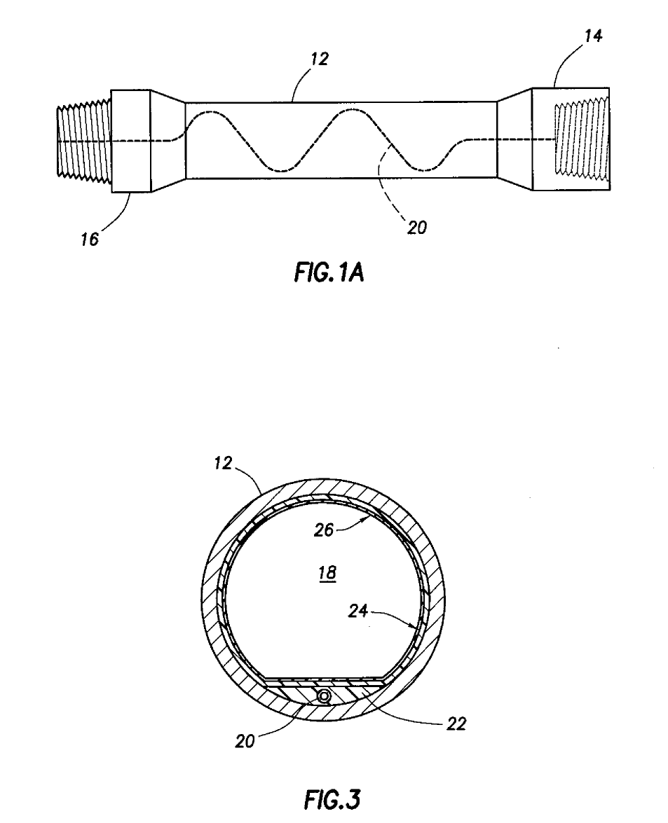

FIG. 1 illustrates a pipe joint 10, which may be a segment or “joint” of wired drill pipe. The pipe joint 10 includes an example configuration of a guide tube or conduit providing a power and/or signal channel, such as an electrical conductor or an optical fiber. The pipe joint 10 is typically made from steel, or other high strength metal. The pipe joint 10 may also be made from non-magnetic alloy such as stainless steel, monel or an alloy sold under the trademark INCONEL, which is a registered trademark of Huntington Alloys Corporation, Huntington, W. Va. The pipe joint 10 includes at its longitudinal ends what are referred to as “tool joints” as shown at 14 and 16. Tool joints 14, 16 are longitudinal endmost sections of the pipe joint 10. The body of the pipe joint 10 extends between the tool joints 14, 16. The pipe joint 10 has a bore extending through the body and the tool joints 14, 16. In an embodiment, the tool joints 14, 16 have a greater wall thickness than the central portion 12 of the pipe joint 10. The tool joints 14, 16 may include threaded couplings 14A, 16A formed therein. The threaded couplings 14A, 16A may be used to couple the pipe joints end to end to form a “string” of pipe. Typical pipe joints include one internally threaded or female coupling, shown at 14A and referred to as a “box end” or “box” on one longitudinal end, and a male or externally threaded coupling at the other longitudinal end, shown at 16A and referred to as a “pin end” or “pin.” The pin 16A and box 14A may each include a planar surface called a thread shoulder 16B, 14B. For example, one thread shoulder may contacts a corresponding shoulder of an adjacent pipe joint when the pipe joint 10 is threadedly coupled to an adjacent pipe joint. In some examples, a nose 16C of the pin 16 and a mating surface 14C inside (at the “base” of) the box 14 may be planar surfaces that form a metal to metal seal when the pipe joints are threadedly engaged.

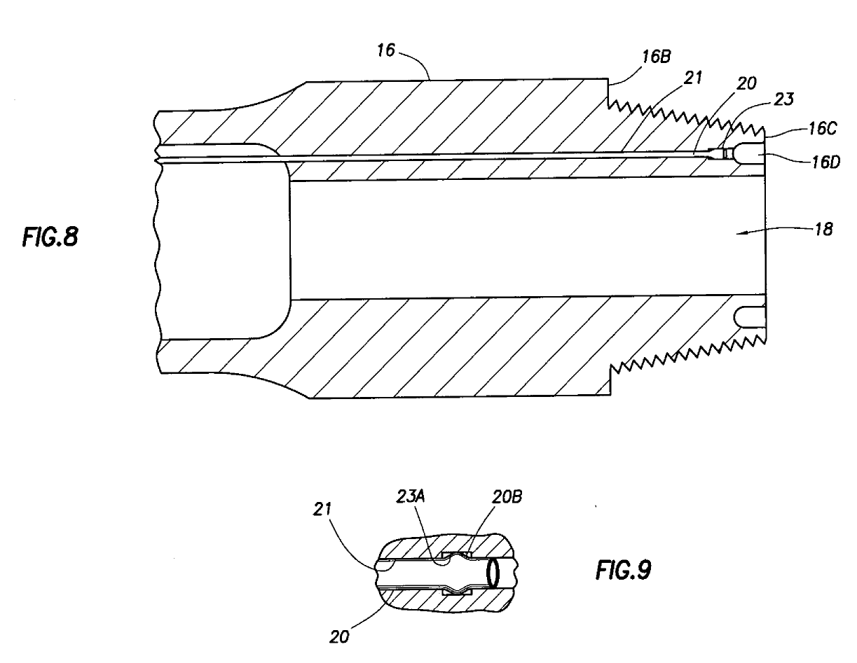

The pin nose 16C and the box base 14C each may include a provision (see FIG. 8) for containing a communication coupling (not shown) such as an electromagnetic coupling. Such communication coupling (not shown) can be, for example, an electrical, inductive and/or optical coupling of types known in the art for transferring electrical power and/or data signals. One example of such coupling (not shown) is described in the Madhavan et al. '926 patent application publication referred to above. The structure of the communication coupling is not intended to limit the scope of the present invention. As will be appreciated by those skilled in the art, a conduit 20 that partially, substantially or fully encloses one or more insulated electrical conductors (not shown) and/or optical fibers (not shown) may provide a protective enclosure for such conductors and/or fibers along the length of the pipe joint 10. Such protection is provided against, for example, abrasion by reason of contact of the pipe joint 10 with the wall of the wellbore during drilling, and/or fluid inside or external to the drill string (including, for example, pipe joint 10). Because the central portion 12 of the pipe joint 10 typically has smaller wall thickness than the tool joints 14, 16, structures for wired drill pipe typically include passage of the conduit 20 from a bore (see FIG. 8) longitudinally through the wall of the tool joint (both of 14, 16 in FIG. 1) to the interior 18 of the central portion 12 of the pipe joint 10. Thus, the conduit 20 may be exposed to the interior 18.

In an embodiment, the conduit 20 may extend through the interior 18 in a helical pattern, as shown in FIG. 1. The conduit 20 may also be arranged in the interior 18 in a wave pattern or any other pattern that causes the length of the conduit 20 within the interior 18 to exceed the length of the interior 18 between the tool joints 14, 16. One example of such arrangement is shown in FIG. 1A, which is a plan view of a pipe joint in which the conduit 20 is configured in a “wave” like pattern. For both the examples shown in FIG. 1 and FIG. 1A, the conduit 20 may have an overall length selected such that the conduit 20 remains in compression notwithstanding bending of the pipe joint 10.

Such arrangements for the conduit 20 as the examples shown in FIG. 1 and FIG. 1A provide that a change in dimension of the interior 18 by reason of stresses applied to the pipe joint 10 during drilling operations will not be directly transmitted to the conduit 20. For example, if the pipe joint 10 undergoes bending stress during drilling, such stress will cause a lengthening of the interior along the outside of the bend and shortening along the inside of the bend. By arranging the conduit 20 as shown in FIG. 1 or FIG. 1A, or in any similar pattern as described herein, such stress will be distributed so as to lessen the overall length change in the conduit 20. Such arrangement is believed to provide reduced incidence of failure of the conduit 20. As explained above, in the present example a length of the conduit 20 may be selected such that when the conduit 20 is disposed as shown in FIG. 1 or FIG. 1A, it is substantially in axial compression. By maintaining the conduit 20 in axial compression and distributing bending forces as explained above, it is believed that the conduit will resist kinking or other bending-induced failure.

The conduit 20 in the present example may be made from steel or other high strength metal to resist crushing under hydrostatic pressure. The conduit 20 may be secured to, attached to, or otherwise connected to the interior wall of the pipe joint 10. For example, the conduit may be bonded to the pipe joint, such as at selected positions along the interior wall of the pipe joint 10, or may be bonded along the entire length of the conduit 20. Bonding may be performed, for example, by welding, by brazing, or adhesively such as by using epoxy, thermoplastic, elastomer or similar material. A cross section of the pipe joint 10 shown in FIG. 2 illustrates using epoxy, thermoplastic or similar material, at 22, to bond the conduit 20 to the pipe joint 10 wall in the interior 18. In some examples, the epoxy or other material 22 may entirely cover the conduit 20, such as shown in FIG. 2. A person having ordinary skill in the art will appreciate other ways of securing or connecting the conduit 20 to the interior wall of the pipe joint 10 and the present invention should not be deemed as limited to the specific examples disclosed herein.

In other examples, the conduit 20 may be made from non-metallic material such as plastic. One example of a suitable plastic is polytetrafluoroethylene (PTFE). In some examples, a PTFE or other plastic tube may have electrically conductive particles such as powered iron or powered graphite suspended in the plastic. Such electrically conductive suspension may provide a non-metallic tube with electrostatic shielding capability.

Another example of retaining the conduit 20 in the interior 18 is shown in a cross sectional view in FIG. 3. The conduit 20 may be arranged in the interior 18 in a pattern such as shown in FIG. 1, or may be extended substantially straight from one tool joint to the other (14, 16 in FIG. 1) in the interior 18. Prior to insertion of the conduit 20, the wall of the interior 18 maybe coated with a corrosion inhibiting layer 24 such as epoxy or other corrosion inhibiting material. In an embodiment, the conduit 20 may be embedded in the epoxy or similar material 22 over its entire length within the interior 18 to prevent crushing during installation of a liner 26 within the interior 18. The liner 26 may be made from steel or other high strength metal, and may be made to conform to the interior wall of the pipe joint 10 and be frictionally retained therein by hydroforming or other radial plastic expansion process. In some examples, the corrosion inhibiting layer 24 may be cured after installation of the liner 26 to improve bonding of the liner 26 to the inner wall of the pipe joint 10 and to improve corrosion protection. Extending the conduit 20 straight from one tool joint to the other along the interior 18 in the present example may provide the advantage of facilitating replacement of electrical and/or optical conductors (not shown) inside the conduit 20 should such replacement prove necessary. In a configuration as shown in FIG. 3, the conduit 20 may be made from plastic or similar material (e.g., PTFE as mentioned above, with or without suspended electrically conductive particles). Depending upon the use, the conduit 20 may be selected such that the combined crush resistance of the material 22 and the conduit 20 are sufficient to withstand expected hydrostatic pressure inside the pipe joint 10 during use, as well as pressure from plastic radial expansion of the liner 26 during manufacture.

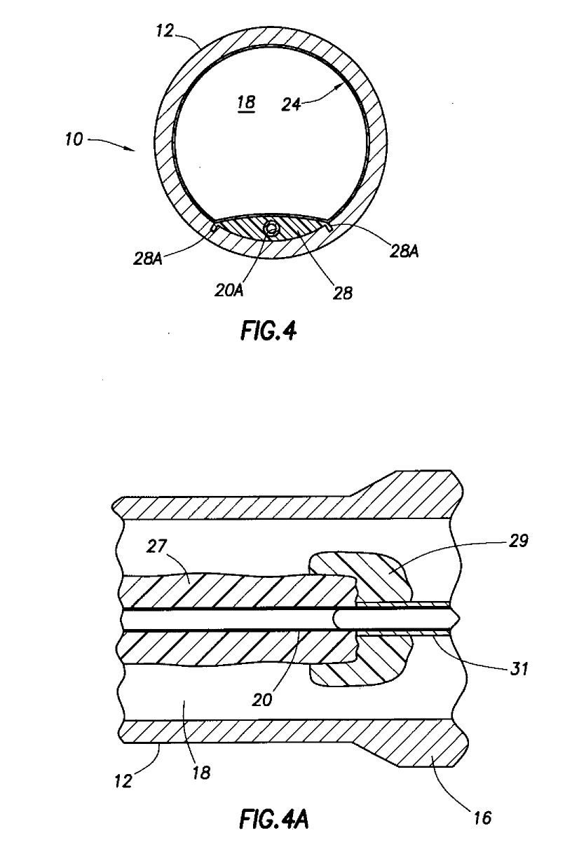

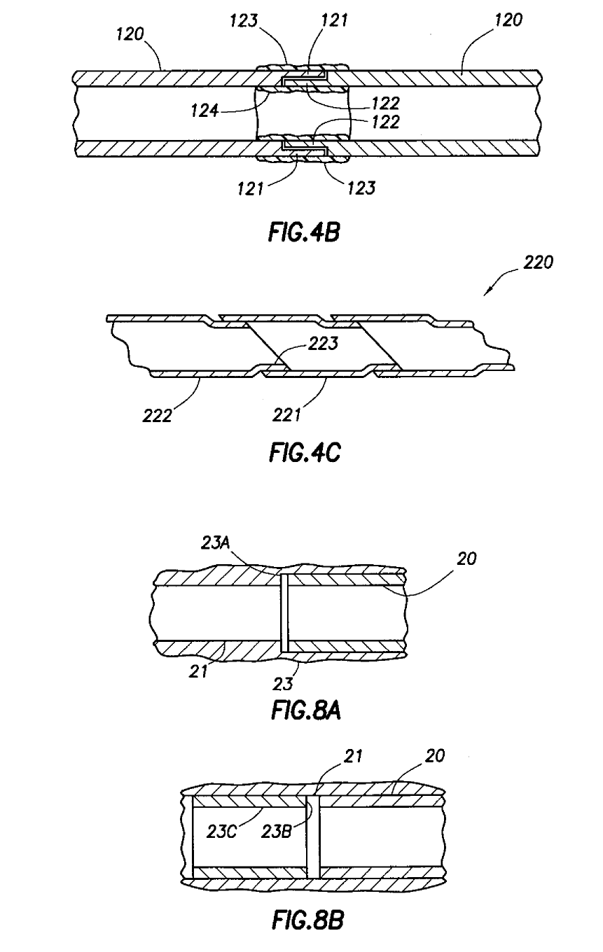

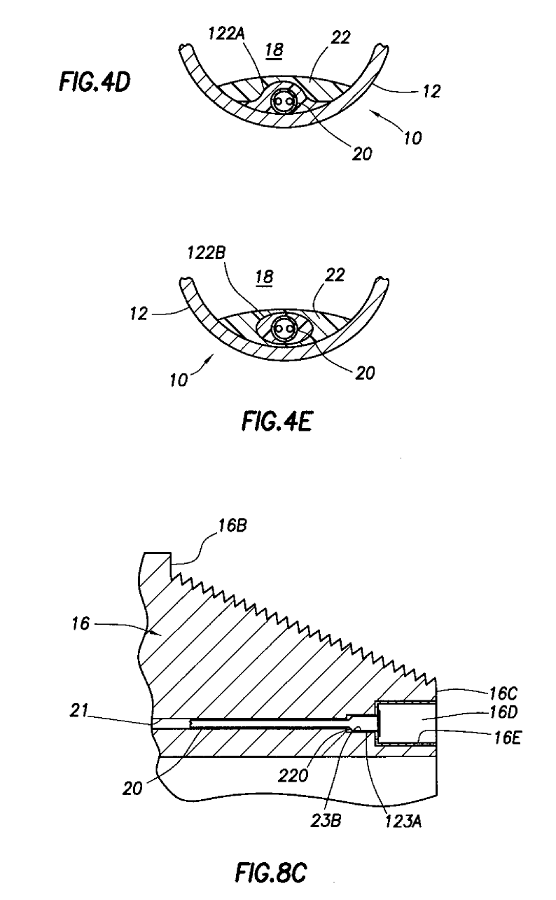

FIG. 4 shows another example of providing a wire guiding conduit for electrical conductors and/or optical fibers. A composite wire guide structure, (the term “wire guide” intending to include a cable, an optical fiber or any other electrical conductor or signal carrying structure) shown generally at 28, may be formed, for example, by using a plastic or composite material tube 20A. In an embodiment, the composite wire guide structure 28 may be formed by molding or curing the tube 20A into a structure formed from composite material. The composite material may be, for example, fiber (e.g., glass, aramid or carbon fiber) reinforced epoxy, elastomer or thermoplastic. The wire guide structure 28 may be formed inside the pipe joint 10 during cure or set up of the composite material, or in some examples may be preformed, and made to a length selected to fit inside the pipe joint 10. The wire guide structure 28 may be constructed in predetermined lengths, such as long (hundreds of feet or more) sections, and may be spooled for later cutting to length. Alternatively, the wire guide structure 28 may be made in suitable predetermined lengths for insertion into pipe joints for manufacture of wired drill pipe.

In some examples, the material used to make the wire guide structure 28 is formed in discrete layers to provide additional crushing resistance for the expected hydrostatic pressure inside the drill string in a wellbore. As previously explained, in some examples of the wire guide structure 28, the tube 20 can be made from material such as PTFE, and may be provided with suitable coatings or other externally applied material to enhance bonding with epoxy or thermoplastic. When such materials are used rather than steel or other metal for the tube or conduit 20, it may be desirable to provide a woven or braided metal shield (see e.g., FIGS. 4D and 4E) to cover insulated electrical conductors that may be inserted into the tube 20 to provide electrostatic shielding. It is also possible to make a preformed wire guide structure such as shown in FIG. 4 without the use of a separate tube 20A. In such examples, it may be possible to form a channel or conduit in the wire guide structure 28 itself by suitable molding, machining or other procedures.

In the example shown in FIG. 4, the wire guide structure 28 if preformed may be shaped to substantially conform to an inner surface of the central portion 12 pipe joint 10 and can in some examples include alignment flanges 28A on one or both lateral edges for mating with corresponding grooves formed in the interior wall of the center portion 12. Thus, the preformed wire guide structure 28 may be readily inserted into the pipe joint in its correct position and removed therefrom when required. If the wire guide structure 28 is preformed as in the above examples, it may be bonded to the interior of the pipe joint 10 using epoxy or the like. Alternatively, if the wire guide structure 28 is to be molded or formed in place inside the pipe joint, the material used to make the wire guide structure 28 preferably has suitable properties to enable it to bond to the interior surface of the pipe joint 10, and/or the pipe joint 10 may be coated on its interior with a suitable bond enhancing material.

For installing a preformed wire guide structure such as shown in FIG. 4 in a pipe joint, it may be desirable to provide an alignment tube (not shown) or similar device to align the conduit 20A with a bore (see 21 in FIG. 8) in each of the tool joints (14, 16 in FIG. 1). Thus aligned, an electrical conductor and/or optical fiber may be readily inserted all the way through the pipe joint 10. Such alignment tube may be used whether or not the structure 28 includes one or more alignment flanges 28A.

In some examples, the conduit 20 may be provided with an additional protective layer in the general area where the conduit 20 enters or is otherwise positioned in the bore through the tool joint. One example of such additional protective layer is shown in FIG. 4A. The view in FIG. 4A is a cross section along the interior of a pipe joint proximate the junction of the central portion 12 with a tool joint 16. The view in FIG. 4A is as if the pipe joint were cut along its longitudinal axis. The conduit 20 may be any configuration as explained above, and may be bonded to the interior pipe wall using epoxy 27 as explained above or may otherwise be affixed to the interior pipe wall. Where the conduit 20 enters the bore 31 through the tool joint 16 (such bore extending to the thread flange as explained above), the conduit 20 may undergo some bending in order to suitably enter the bore 31. Such bending may expose such portion of the conduit 20 to stresses including abrasion caused by the flow of fluid through the interior of the tool joint 16. In the present example, the conduit 20 may include an additional protective layer 29 disposed over the area where the conduit 20 enters the bore 31. The protective layer 29 may be made from materials that are resistant to abrasion, including, for example, nitrile rubber or other elastomer. The material for the protective layer 29 is not limited to these materials and may be made from a combination of these materials and/or other materials that will be appreciated by those of ordinary skill in the art, for example, fiber reinforced epoxy, fiber reinforced thermoplastic, or a metal, such as steel. In an embodiment, the protective layer 29 may be adhesively bonded to the interior wall of the pipe joint or otherwise affixed thereto.

An alternative structure for the conduit intended to reduce transmission of stresses along the conduit is shown in FIG. 4B. In the present example, the conduit may be formed from axial segments 120 of selected length coupled end to end. The ends of the conduit segments 120 may be joined by providing one end of the conduit segment 120 with an increased internal diameter portion 121. Such portion 121 may be formed, for example, by machining or otherwise removing a portion of the thickness of the interior wall of the conduit segment 120. A corresponding reduced outer diameter portion 122 may be formed in the longitudinal end of an adjoining conduit segment 120 by removing material from the outer wall of the portion 122. Those skilled in the art will readily appreciate that such portions 121, 122 may also be formed by suitable molding and plastic deformation techniques. The portions 121, 122 may be configured such that when one is assembled to the other as shown in FIG. 4B, the conduit traverses a substantially constant internal and external diameter across the juncture of the segments 120. Where the portions 121, 122 are coupled, in some examples the juncture may be externally sealed, such as by using heat shrinkable tubing 123. The interior of the juncture may be additionally sealed or held together using a soft material sleeve 124 such as made from elastomer or plastic. A longitudinal end gap may be configured between the longitudinal ends of adjacent conduit segments 120. Depending on the number of such segments 120, the gap between any two adjacent segments will be related to the length of the pipe joint in which the conduit segments 120 are installed.

Another example structure for the wire conduit is shown in FIG. 4C. The conduit 220 may be formed from a single sheet of material including a first surface 222 and a second surface 222 formed by bending or molding, depending on the material used. The sheet of material may be wound in a helical pattern as shown in FIG. 4C to form a flexible, continuous conduit 220. Those skilled in the art will recognize the structure as similar to helical, interlocking cable armor. The sheet of material may include interlocking features (not shown) to prevent longitudinal separation after helical winding. The conduit 220 shown in FIG. 4C in some examples may be externally sealed using heat shrinkable tubing or the like as explained above with reference to FIG. 4B.

Other example structures for retaining the conduit inside the pipe joint are shown in FIGS. 4D and 4E. In FIG. 4D, a fiber braid or wire braid may be formed to make a reinforcing layer 122A when disposed in a plastic retaining layer 22 (which may be made from, for example, epoxy, resin or thermoplastic). The reinforcing layer 122A serves to provide strength to the retaining layer 22. Alternatively, as shown in FIG. 4E, the reinforcing layer 122B may be in the form of a closed tube or conduit. For either example shown in FIG. 4D and 4E, the reinforcing layer is disposed over the conduit 20 prior to application or cure of the retaining layer 22.

Another device for retaining a conduit, cable, electrical conductor and/or optical fiber inside a pipe joint will now be explained with reference to FIGS. 5, 6 and 7. FIG. 5 shows a cross section of the central potion 12 of a pipe joint (10 in FIG. 1). The interior 18 includes an insert 30, which may be a biased insert having a spring-like force against the inside of the pipe joint 10. In the embodiment shown, the insert 30 is generally C-shaped, and is made from a spring metal material. The insert 30 may include a longitudinally extending feature or recess, shown at 36, formed in its outer surface to retain the conduit 20, which may extend straight through the interior 18 from one tool joint to the other. The recess 36 may be substantially similar in size and shape to a size and shape of the conductor, cable, fiber or other structure for transmitting power and/or signals along the pipe joint 10. For example, the recess 36 may have a diameter substantially similar to the diameter of the conductor, cable, fiber or other structure for transmitting power and/or signals along the pipe joint 10. It is also within the scope of this example to have an electrical conductor, cable, or optical fiber pass directly from one tool joint to the other inside the feature or recess 36.

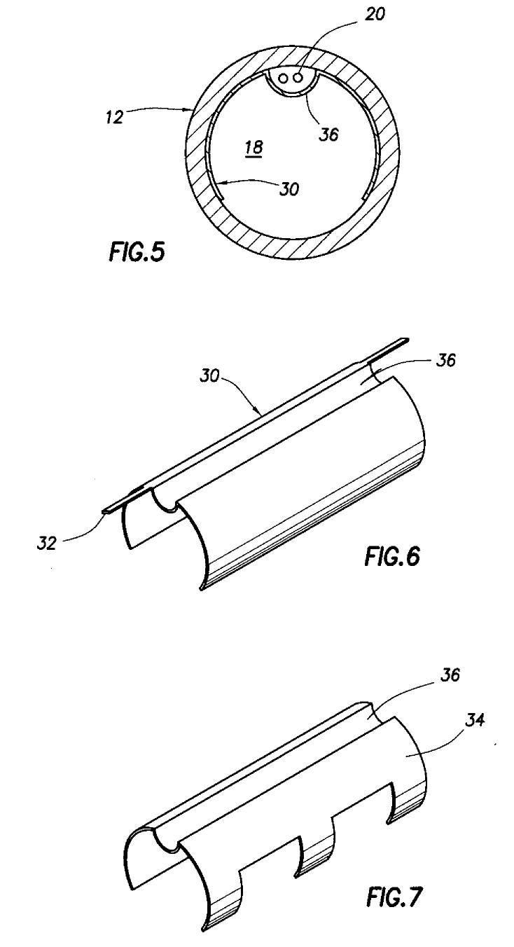

The material from which the insert 30 is made is preferably a resilient metal such as phosphor-bronze or similar material having good spring properties. An uncompressed diameter of the insert 30, and an amount of spring force are preferably selected so that the insert 30 may be retained inside the pipe joint 10 by friction. The insert 30 may be installed inside the pipe joint 10 by circumferentially compressing the insert 30 to reduce its diameter. When the compression is released, the insert 30 expands diametrically and is retained in the interior 18 by friction. Some examples of an insert, such as the one shown in FIG. 6 may include lock tabs 32 on one or both longitudinal ends to retain the insert 30 in its longitudinal position by placement thereof in a corresponding feature (not shown) formed inside the pipe joint (10 in FIG. 1).

The insert 30 may be configured so that the lock tabs 32 have dimensions selected to substantially cover the protective layer (see FIG. 4A) used in some examples. The insert 30 may have a circumferential dimension selected such that the insert 30 contacts more than 180 degrees of the inner circumference of the pipe joint 10. In another example, shown in FIG. 7, the insert 30 may have substantial portions of its exterior circumference away from the channel 36 removed, thereby covering substantially less than 180 degrees of the pipe interior except along selected axial segments. The example shown in FIG. 7 serves to reduce the compressing force needed to install the insert 30 inside the pipe joint (10 in FIG. 1).

In some examples it may be desirable to structure the conduit 20 and the bore (FIG. 8) in which the conduit passes through the tool joint (14 and 16 in FIG. 1) to axially retain the end of the conduit 20 in place within such bore. Referring to FIG. 8, the pin 16 is shown to illustrate one such example. The nose 16C of the pin 16 includes a recess 16D for retaining the communication device (not shown). The recess 16D may be a semi-circular groove or channel formed in the pin nose 16C. A bore 21 having diameter sufficient to enable the conduit 20 to freely pass therethrough is formed so as to extend from the interior base of the recess 16D inwardly beyond the longitudinal end of the tool joint 16 so that the bore 21 terminates inside the interior 18. Proximate the end of the bore 21 that enters the recess 16D, the bore 21 may include, for example, a larger diameter segment or portion, which is shown at 23. During the manufacturing process, after the conduit 20 is inserted into the bore 21 and is extended through the interior 18 through a corresponding bore (not shown in FIG. 8) in the other tool joint (e.g., 14 in FIG. 1), the conduit 20 may be radially, plastically expanded to secure it in place inside the larger diameter portion 23. Such diametric expansion will reduce any tendency of the conduit 20 to be pulled out of the bore 21. The exact longitudinal position of the larger diameter portion 23 with respect to the end of the bore 21 is not a limit on the scope of the invention. For example, with reference to FIG. 9, the larger diameter portion 23A may be away from the longitudinal end of the bore 21. There may also be a plurality of larger diameter portions in other examples.

In still other examples, the conduit 20 may be secured to the inside of the bore 21 by frictional forces. In such examples, the bore need not include a larger diameter portion. Radial plastic deformation of the conduit 20 may be performed so as to provide sufficient friction between the conduit 20 and the bore 21 to retain the conduit 20 in the bore 21 notwithstanding axial stress imparted to the conduit.

An alternative example is shown in FIG. 8A. In certain examples, such as the one shown in and explained with reference to FIG. 1 and FIG. 1A, the conduit 20 may exert unwinding or other stress such that the longitudinal ends of the conduit 20 may be held in compression within the respective bores in the tool joints. The conduit 20 may be retained in place longitudinally within the bore 21 by providing a larger diameter section 23 terminated longitudinally with a shoulder 23A or similar feature such that the conduit 20 is effectively prevented from moving longitudinally past the shoulder 23A. After insertion of the conduit 20 into the pipe joint, the longitudinal ends of the conduit 20 may be radially plastically expanded as explained above so that the longitudinal ends of the conduit 20 fit as shown within the larger diameter portion 23A of each bore 21.

Another example shown in FIG. 8B provides that the bore 21 may have uniform internal diameter and the shoulder 23B may be formed by inserting a stop tube 23C into the bore and radially plastically expanding the stop tube 23B so that it is frictionally retained within the bore 21.

Yet another example of a device to longitudinally retain the conduit is shown in FIG. 8C. The bore 21 in FIG. 8C may include a larger diameter portion 123A that terminates at the interior base of the groove 16D for the coupling (not shown). The groove 16D may include a sleeve 16E therein made from copper, sliver, gold, or other high conductivity metal to increase performance of the electromagnetic coupling (not shown). A retaining tube 23B may be plastically deformed to be retained in place inside the larger diameter portion 123A either by flaring the end thereof or by interference fit inside the larger diameter portion 123A. The longitudinal end of the conduit 20 may be flared, at 220 so that it contacts a longitudinal end of the retaining tube.

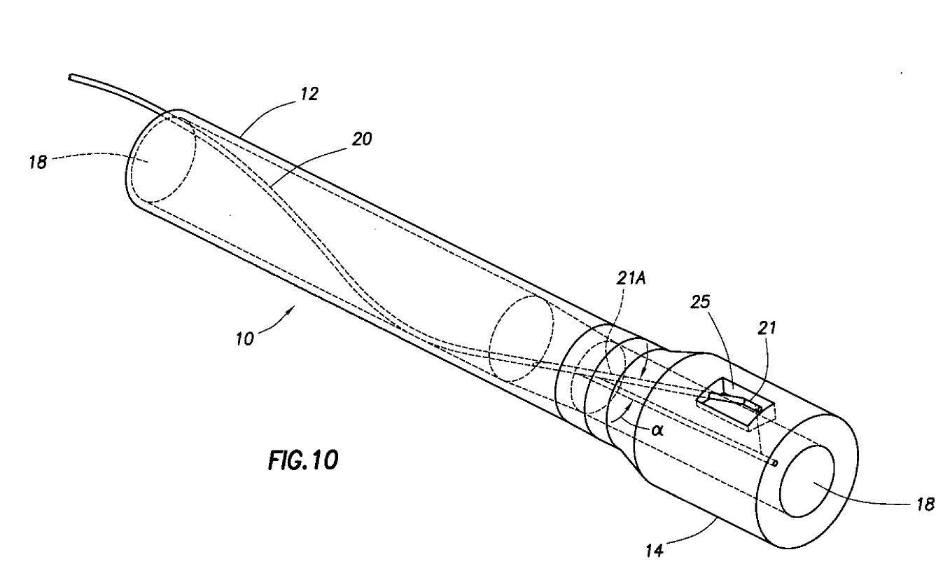

Another example of a bore through a tool joint to couple the interior 18 with the groove or recess (16D in FIG. 8) is shown in FIG. 10. The bore includes an angled segment 21A that terminates in the interior 18 and subtends a non-zero angle a with respect to a longitudinal axis of the pipe joint 10. The angle a may be selected such that the angled segment 21 is out of parallel with the longitudinal axis of the pipe joint along just one direction, or in some examples along two orthogonal directions. In some examples, the angle may be in a range of about five to forty degrees. A segment of the bore 21 formed as explained with reference to FIG. 8 may intersect an end of the angled segment 21A at a junction 25 provided for machining purposes. In making a wired pipe joint as shown in FIG. 10, a conduit 20 may be inserted into the angled segment 21A beginning at the junction 25. By inserting the conduit 20 at an angle by reason of the angled segment 21A, the conduit 20 will have a tendency to wind itself about the interior in a helical patter as shown in FIG. 1. After insertion of the conduit 20 as shown in FIG. 10, and after insertion of the conductor (not shown), the junction 25 may be sealed, such as by welding or inserting an epoxy or thermoplastic plug I (now shown). The conduit 20 may be affixed at either or both longitudinal ends according to the examples explained above.

Structures for wired drill pipe according to the various aspects of the invention may provide easier wire replacement, greater resistance to damage during use of the wired drill pipe, and less cost to manufacture than other configurations for wired drill pipe.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A pipe joint structure comprising:
a body extending from a first tool joint to a second tool joint, the first tool joint and the second tool joint positioned at opposing ends of the pipe joint;
a bore extending within the interior of the body and defining an interior of the pipe joint;
a cable positioned along the interior of the pipe joint and through the bore; and
an insert biasing the cable against the pipe joint, the insert circumferentially biasing the cable against the pipe joint.

2. The pipe joint of claim 1 wherein the insert extends circumferentially around less than 180 degrees of a circumference of the pipe joint.

3. The pipe joint of claim 1 wherein the insert extends circumferentially around more than 180 degrees of a circumference of the pipe joint.

4. The pipe joint of claim 1 wherein the insert has a longitudinal recess substantially similar in size and shape to a size and shape of the cable.

5. The pipe joint of claim 1 wherein the insert has lock tabs to longitudinally retain the insert within the pipe joint.

6. A pipe joint structure comprising:
a tool joint at each longitudinal end of the pipe joint, each tool joint having a bore therethrough extending from a thread face on the tool joint to an interior of the pipe joint; and
a circumferentially outwardly biased insert extending along the interior of the pipe joint from at least an interior end of one bore to an interior end of the other bore, a biasing of the insert configured to cause releasable frictional engagement of the insert to the interior of the pipe joint, the insert including a longitudinally extending feature for covering a conductor extending between the tool joints.

7. The structure of claim 21 wherein the retaining feature comprises a channel.

8. The structure of claim 21 wherein the insert includes a plurality of axial segments each covering less than 180 degrees of an interior circumference of the pipe joint.

9. The structure of claim 21 wherein the insert comprises a lock tab at least one longitudinal end thereof.

10. A method for retaining a cable capable of transmitting power or data along a pipe joint comprising:
inserting the cable into an interior of the pipe joint;
circumferentially compressing an insert to a first diameter less than a diameter of the pipe joint; and
positioning the insert in the pipe joint such that the cable is positioned between the pipe joint and the insert;
releasing the insert to a second diameter that biases the cable against the interior of the pipe joint.

11. The method of claim 1 wherein the insert has a lock tab maintaining a longitudinal position of the insert with respect to the pipe joint.

12. The method of claim 1 wherein the insert extends about more than 180 degrees of the interior of the pipe joint.

13. The method of claim 1 wherein the insert extends about less than 180 degrees of the interior of the pipe joint.
